(19) United States
(12) Patent Application Publication
(10) Pub. No.: US 2014/0297750 A1
(43) Pub. Date: Oct. 2, 2014

(54) INFORMATION PROVIDING SYSTEM, INFORMATION PROVIDING PROGRAM AND INFORMATION PROVIDING METHOD

(71) Applicant: DeNA Co., Ltd., Tokyo (JP)

(72) Inventors: Tomoyuki SHIMADA, Tokyo (JP); Shinya MASUDA, Tokyo (JP)

(73) Assignee: DeNA Co., Ltd., Tokyo (JP)

(21) Appl. No.: 14/221,094

(22) Filed: Mar. 20, 2014

(30) Foreign Application Priority Data
Mar. 28, 2013 (JP) 2013-068418

(51) Int. Cl. H04L 12/18

(52) U.S. Cl. CPC H04L 12/1813
USPC 709/204

(57) ABSTRACT

An information providing system appropriately filtering post contents posted by users is provided. An information providing system according to one embodiment of the present invention includes one or more processors executing a given program. The program includes a selecting module selecting one or more particular post contents from among a plurality of post contents posted by one or more users in association with a particular webpage on the basis of rating information for the post contents, a feed information generating module generating particular feed information including the particular post content or contents, and a feed information delivery module delivering the particular feed information.

### CROSS-REFERENCE TO RELATED APPLICATIONS

This application is based on and claims the benefit of priority from Japanese Patent Application Serial No. 2013-068418 (filed on Mar. 28, 2013), the contents of which are hereby incorporated by reference in their entirety.

### TECHNICAL FIELD

The present invention relates to an information providing system, an information providing program and an information providing method and, in particular, to an information providing system, an information providing program and an information providing method that deliver feed information.

### BACKGROUND

Social networking services (hereinafter referred to as “SNS”) which promote and facilitate building social relations among users through websites are known. An example of SNS is “Facebook” (trademark) provided by Facebook, Inc. In an SNS, users can post contents such as diaries, brief comments, photographs and videos on webpages (user pages) allocated to the users and communicate with other users by viewing the posted contents and posting comments on the contents. Various other functions for promoting communication among users are provided in SNS.

SNSs include the function of feeding a content posted on a user page of a given user or feed information edited from the content to other users who are in a friendship with the user or other users who have “subscribed” to the user page (for example, see National Publication of International Patent Application No. 2011-504260). Feed information is delivered for example when a new content is posted on the user page. Feed information can include various kinds of information such as a diary updated by the user, comments posted on the user page by other users, and links to news articles.

A user who obtained feed information can visit a website linked on the received feed information or post a comment on a content included in the feed information. In this way, the users of SNS can browse a new content posted on the user page by receiving feed information without bothering to access a user page.

### SUMMARY

However, not all the contents included in feed information are interesting to users who received the feed information. Especially contents posted on a user page of a given user by other users often do not attract the interest of users who have received the feed information. Receiving feed information including a large amount of information that is not interesting is not only bothersome but also causes the problem of hindering the user from noticing information interesting to the user. The problem is becoming more and more serious as friendships within SNS expand or the number of webpages to which a user has subscribed increases. Therefore it is desirable that feed information including appropriately filtered contents alone.

One object of the present invention is to provide an information providing system that appropriately filters post contents posted by users. Other objects of the present invention will be apparent from the following specification.

An information providing system according to one embodiment of the present invention provides information through a website and includes one or more processors capable of executing a given program. In one embodiment of the present invention, the program includes a webpage providing module providing a particular webpage within the website to a plurality of users of the website, a post content acquiring module acquiring a plurality of post contents posted by one or more users included in the plurality of users in association with the particular webpage, a rating accepting module accepting rating information representing a rating for at least one of the plurality of post contents from one or more users included in the plurality of users, a selecting module selecting one or more particular post contents from among the plurality of post contents on the basis of the rating information, a feed information generating module generating particular feed information including the particular post content or contents, and feed information delivery module delivering the particular feed information.

An information providing program according to one embodiment of the present invention provides information through a website. An information providing program according to one embodiment of the present invention causes a computer to execute a webpage providing process providing a particular webpage within the website to a plurality of users of the website, post content acquiring process acquiring a plurality of post contents posted by one or more users included in the plurality of users in association with the particular webpage, a rating accepting process accepting rating information representing a rating for at least one of the plurality of post contents from one or more users included in the plurality of users, a selecting process selecting one or more particular post contents from among the plurality of post contents on the basis of the rating information, a feed information generating process generating particular feed information including the particular post content or contents, and feed information delivery process delivering the particular feed information.

An information providing method according to one embodiment of the present invention is executed by a computer that provides information through a website. An information providing method according to one embodiment of the present invention includes a webpage providing step of providing a particular webpage within the website to a plurality of users of the website, a post content acquiring step of acquiring a plurality of post contents posted by one or more users included in the plurality of users in association with the particular webpage, a rating accepting step of accepting rating information representing a rating for at least one of the plurality of post contents from one or more users included in the plurality of users, a selecting step of selecting one or more particular post contents from among the plurality of post contents on the basis of the rating information, a feed information generating step of generating particular feed information including the particular post content or contents, and feed information delivery step of delivering the particular feed information.

Embodiments of the present invention can provide an information providing system that appropriately filters post contents posted by users.

### BRIEF DESCRIPTION OF THE DRAWINGS

FIG. 1 is a block diagram schematically illustrating a network configuration including a system according to one embodiment of the present invention;

FIG. 2 is a block diagram conceptually illustrating an architecture of a terminal device in one embodiment of the present invention;

FIG. 3 is a block diagram illustrating functions of a system in one embodiment of the present invention;

FIG. 4 illustrates an example of a post content management table in one embodiment of the present invention;

FIG. 5 illustrates an example of a related content management table in one embodiment of the present invention;

FIG. 6 illustrates an example of display of an operator page in one embodiment of the present invention;

FIG. 7 is a flowchart illustrating a process flow from an operation for logging into an SNS to calculation of a rating value for a content according to one embodiment of the present invention;

FIG. 8 is a flowchart illustrating a process for accepting a post content according to one embodiment of the present invention;

FIG. 9 is a flowchart illustrating a process for collecting related contents according to one embodiment of the present invention;

FIG. 10 is a flowchart illustrating a process flow from logging into an SNS to an operation for delivering feed information to a user page; and

FIG. 11 is an example of display of a user page in one embodiment of the present invention.

### DESCRIPTION OF EXAMPLE EMBODIMENTS

Various embodiments of the present invention will be described hereinafter with reference to the drawings. In the drawings, the same components are denoted by the same reference numerals.

FIG. 1 is a block diagram schematically illustrating a network configuration including a system according to an embodiment of the present invention. As illustrated in FIG. 1, a server 10 may be communicatively connected to a plurality of terminal devices 30-1, 30-2, . . . , and 30-N (hereinafter also collectively referred to as the “terminal devices 30”), each having a communication function, via a communication network 20 such as the Internet. The server 10 may host a web site in a particular domain and send the web pages in the web site to the terminal 30, thereby to provide various services related to social networking services (SNS) to the user operating the terminal 30.

As shown, the server 10 may include a processor 11, a main memory 12, a user interface (I/F) 13, a communication I/F 14, a storage (external memory) 15, and a disk drive 16, and these components may be electrically connected to one another via a bus 17.

The processor 11 may load various programs such as an operating system into the main memory 12 from the storage 15, and may execute commands included in the loaded programs. The processor 11 may include various information processing mechanisms for electronically processing information, such as a digital processor, an analog processor, a digital circuit designed for information processing, an analog circuit designed for information processing, and a state machine. The processor 11 may be implemented by either a physically single processor or a plurality of physically separate processors. The plurality of processors may be either provided in a single device or distributed among a plurality of devices. More specifically, the processor 11 may implement the modules described later as software, hardware, firmware, or a combination thereof.

The main memory 12 may be used to store a program (or modules therein) to be executed by the processor 11, and may be formed of, for example, a dynamic random access memory (DRAM). The user I/F 13 may include, for example, an information input device such as a keyboard or a mouse for accepting an input from an operator, and an information output device such as a liquid crystal display for outputting calculation results of the processor 11. The communication I/F 14 may be implemented as hardware, firmware, or communication software such as a transmission control protocol/Internet protocol (TCP/IP) driver or a point-to-point protocol (PPP) driver, or a combination thereof, and may be configured to be able to communicate with the terminal devices 30 via the communication network 20.

The storage 15 may comprise, for example, a magnetic disk drive and store an operating system, various programs, and various data. The various data that may be stored in the storage 15 may also be stored on a database server communicatively connected to the server 10 and physically separate from the server 10. The disk drive 16 may read data stored in a storage medium such as a compact disc read only memory (CD-ROM), digital versatile disc read only memory (DVD-ROM), or DVD Recordable (DVD-R) disc, or write data to such a storage medium.

In an embodiment, the server 10 may serve as a web server for communicating with the terminal devices 30 in HTTP to manage a web site including a plurality of hierarchical web pages.

In an embodiment, the terminal 30 may be a desired information processing device including an application execution environment for executing an application including a web browser. Non-limiting examples of the terminal 30 may include mobile phones, smartphones, tablet terminals, personal computers, electronic book readers, and game consoles.

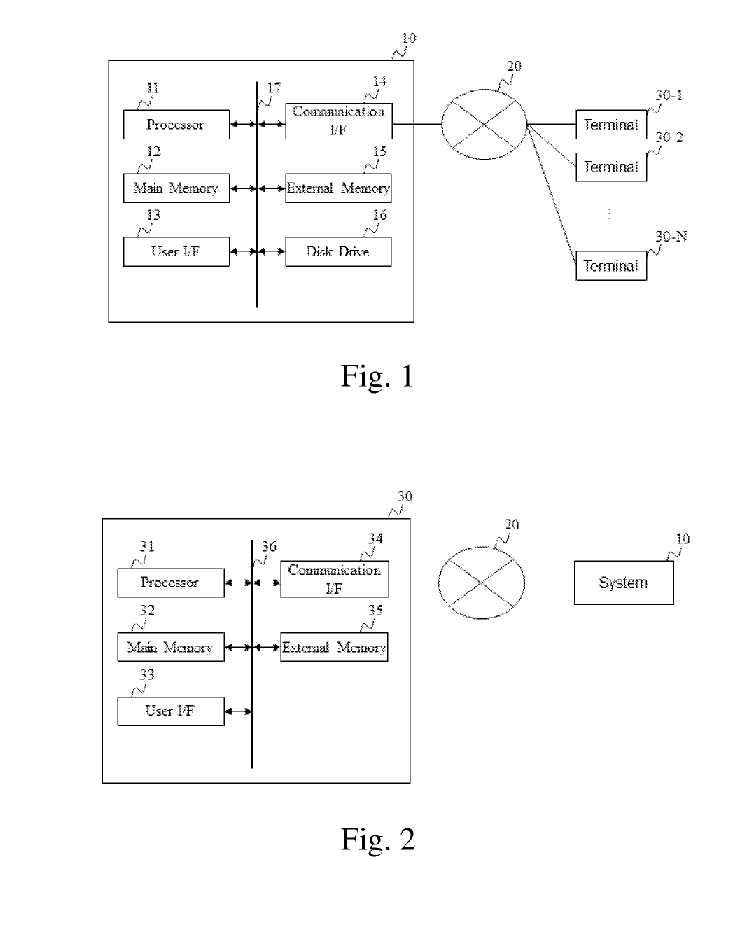

The architecture of the terminal device 30 will now be described with reference to FIG. 2. FIG. 2 is a block diagram schematically illustrating the architecture of a terminal device 30. As shown, the terminal device 30 may include a processor 31, a main memory 32, a user interface (I/F) 33, a communication I/F 34, and a storage (external memory) 35, and these components may be electrically connected to one another via a bus 36.

The processor 31 may load various programs such as an operating system into the main memory 32 from the storage 35, and may execute commands included in the loaded programs. The above description about the processor 11 may also apply to the processor 31 as long as possible. The main memory 32 may be used to store a program to be executed by the processor 31, and may be formed of, for example, a dynamic random access memory (DRAM).

The user I/F 33 may include, for example, an information input device such as a touch panel, a keyboard, a button, and a mouse for accepting an input from a user, and an information output device such as a liquid crystal display for outputting calculation results of the processor 31. The communication I/F 34 may be implemented as hardware, firmware, or communication software such as a transmission control protocol/Internet protocol (TCP/IP) driver or a point-to-point protocol (PPP) driver, or a combination thereof, and may be configured to be able to communicate with the server 10 via the communication network 20. The storage 35 may comprise, for example, a magnetic disk drive or a flash memory and store various programs such as an operating system.

A terminal device 30 having such an architecture may include, for example, browser software for interpreting an HTML file (HTML data) and rendering a screen; this browser software may enable the terminal device 30 to interpret the HTML data fetched from the server 10 and render web pages corresponding to the received HTML data.

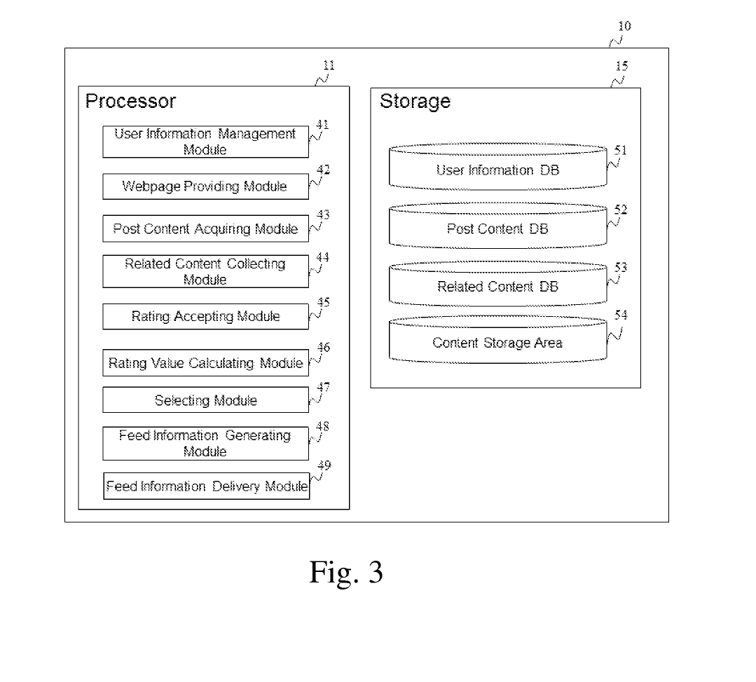

Functions of the server 10 will now be described with reference to FIG. 3. FIG. 3 is a block diagram illustrating functions of the server 10 in one embodiment of the present invention as separate modules. As illustrated, the server 10 may include a program executed by the processor 11 and may include various databases recorded in the storage 15 (or other storage).

The functions of the server 10 may be implemented by various modules executed by the processor 11. As illustrated in FIG. 3, the modules executed by the processor 11 may include a user information managing module 41, a webpage providing module 42, a post content acquiring module 43, a related content collecting module 44, a rating accepting module 45, a rating value calculating module 46, a selecting module 47, a feed information generating module 48, and a feed information delivery module 49. The modules illustrated in FIG. 3 are illustrative only; the server 10 may execute modules other than the illustrated modules or may omit some of the illustrated modules.

The modules can retrieve various kinds of data stored in the storage 15 or store results of processing in the storage 15. The storage 15 may include a user information DB 51, a post content DB 52, a related content DB 53, and a content storage area 54. These databases may be provided in a storage different from the storage 15 of the server 10 or provided in a storage device different from the server 10.

Functions of the modules in FIG. 3 will be further described below. When a user signs up for SNS, the user information managing module 41 may receive various items of user information indicating attributes of the user from the user. The user information managing module 41 can issue a user ID identifying a user to the user who has signed up for the SNS. The user information managing module 41 may record user information received from a user in the user information DB 51 in association with the user ID identifying the user. The user information may include various items of profile information describing attributes of the user, such as the user's name, birth date, alma mater, place of employment and residence. The user can request the server 10 to update the profile information as appropriate. The user information managing module 41 may update the profile information recorded in the user information DB 51 in response to the update request.

The user information managing module 41 may record relationship information indicating a relationship between users set by a user in the user information DB 51. Relationships that can be indicated by the relationship information may include relationships such as friends, husband or wife, and colleague. When a relationship between users has changed, the user information DB 51 can be updated to reflect the change of the relationship.

Furthermore, when the user information managing module 41 may accept a request from a user to deliver feed information on a webpage within a website provided by the server 10, the user information managing module 41 may record a webpage ID (herein sometimes referred to as “subscribed webpage ID”) identifying the webpage that contains the feed information for which the delivery request has been made in association with the user ID of the user in the user information DB 51. When the user has “subscribed” to a new webpage, the user information DB 51 is updated to add the new webpage.

The webpage providing module 42 may use various kinds of data and contents recorded in the storage 15 to generate a webpage to be provided to users and may provide the generated webpage to users through terminal devices 30. More specifically, the webpage providing module 42 may generate a webpage to include post contents (which will be described later) and related contents (which will be described later) stored in the content storage area 54. Users of the SNS provided by the server 10 can view webpages provided by the webpage providing module 42 on terminal devices 30.

Webpages generated by the webpage providing module 42 can be broadly classified as user pages each of which is allocated to each user of the SNS and operator pages managed by the operator of the SNS. A user page may include various kinds of information about the user, such as the profile of the user, post contents posted by the user and other users, advertisements, and a list of friends of the user. A user page may include a dialog box for posting a content in association with the user page. A user page ID for identifying each user page within the SNS is assigned to the user page.

A operator page may be a webpage managed by the operator running the SNS provided using the server 10. Operator pages may be created for each particular subject such as an artist, an athlete, a sport team, an entertainer, a writer, or a music genre. An operator page may include various kinds of information relating to the subject of the operator page such as news relating to the subject of the operator page, post contents such as comments posted in association with the operator page, and advertisements, for example. An operator page may also include a dialog box for posting a content in association with the operator page. An operator page ID for identifying each operator page within the SNS may be assigned to the operator page. Differences between an operator page and a user page will be more apparent from the following description.

As has been described above, user pages and operator pages may include a dialog box for posting contents. A user can use a posting function provided on the webpage to post various contents such as text, photographs, videos, and musical pieces on the webpage. A post content thus posted by a user in associated with a webpage provided by the webpage providing module 42 may be acquired by the post content acquiring module 43. Post contents may include various contents posted by users, such as diaries, comments, photographs, and videos, for example. Diaries, comments, photographs and videos are a few examples of post contents among many; post contents may be in any form.

In addition to using a comment entry field provided on a webpage, a user can use various methods to post a content in association with a webpage. For example, an identifier that identifies each webpage within the website provided by the server 10 may be predetermined to allow a posted content to be associated with a particular webpage by posting a post content in association with the identifier. The identifier in one embodiment may be in the form of a “hashtag”, which includes a sharp sign (#) and one-byte alphanumeric characters, like “#def”. The specific format of the identifier is not limited to the hashtag format; any code that can identify a webpage may be used as the identifier.

The post content acquiring module 43 may store an acquired post content in the content storage area 54. The post content acquiring module 43 may record various kinds of information concerning the acquired post content in the post content DB 52.

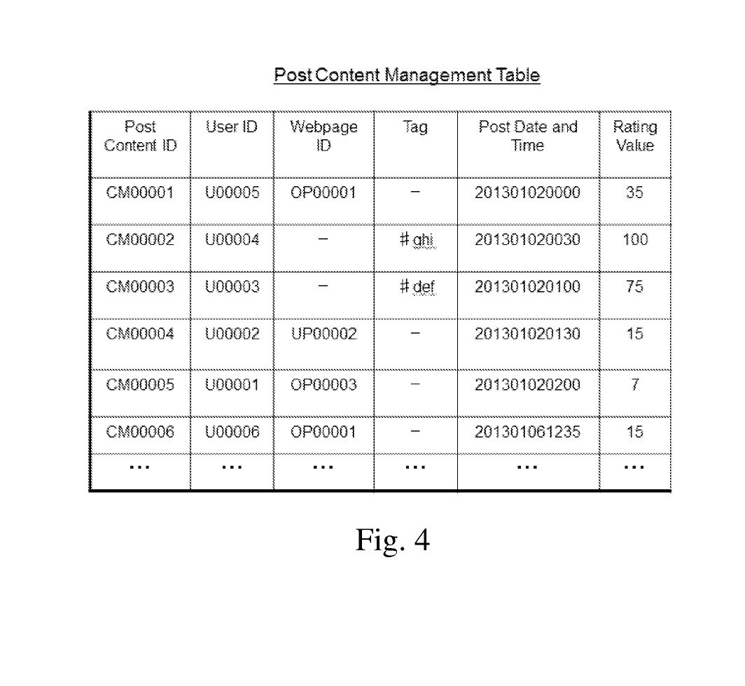

In one embodiment, the post content DB 52 may include a post content management table illustrated in FIG. 4 by way of example. As illustrated in FIG. 4, a “user ID” identifying a user who has posted a post content acquired by the post content acquiring module 43, a “webpage ID” identifying a webpage on which the post content has been posted, a “tag” representing an identifier acquired in association with the post content, a “post date and time” at which the post content has been posted, and a “rating value”, which may be calculated on the basis of rating for the post content given by the user, may be recorded in the post content management table in association with a “post content ID” identifying the post content.

When a user uses the posting or comment function of a given webpage to post a post content on the webpage, the webpage ID that identifies the webpage may be sent to the server 10 along with the post content. When the post content acquiring module 43 acquires the post content and the webpage ID, the post content acquiring module 43 may record the webpage ID in the post content management table in association with the post content ID of the post content. The record recoded in association with the post content ID “CM00001” in FIG. 4 is an example of a record recorded in this way. On the other hand, when a user has posted a post content from the user's user page, for example, together with a hashtag, “#def”, the post content acquiring module 43 records the hashtag “#def” in the post content management table in association with the post content ID of the post content. The record recorded in association with the post content ID “CM00003” is an example of a record recorded in this way.

An ID beginning with “UP” among the webpage IDs in the post content management table in FIG. 4 is an ID identifying a user page and an ID beginning with “OP” is an ID identifying an operator page.

The post content management table may be updated when a new post content is posted or a rating for a post content managed is newly acquired. The post content management table illustrated in FIG. 4 is illustrative only; the post content management table according to the present invention does not need to include all items illustrated and may include an additional item.

The related content collecting module 44 may collect contents relating to a particular webpage (a user page or an operator page) within a website provided by the server 10 from external sites different from the website provided by the server 10 and may store the collected related contents in the content storage area 54. For example, the related content collecting module 44 may collect webpages containing a keyword predetermined for a particular webpage or part of the webpages. Related contents relating to a particular operator page may include news articles and press releases relating to the subject of the operator page, for example. A content that relates to a particular user page or a particular operator page and is collected by the related content collecting module 44 is herein referred to as a “related content”. The term “external site” as used herein means a website provided in a domain different from the domain of the website provided by the server 10.

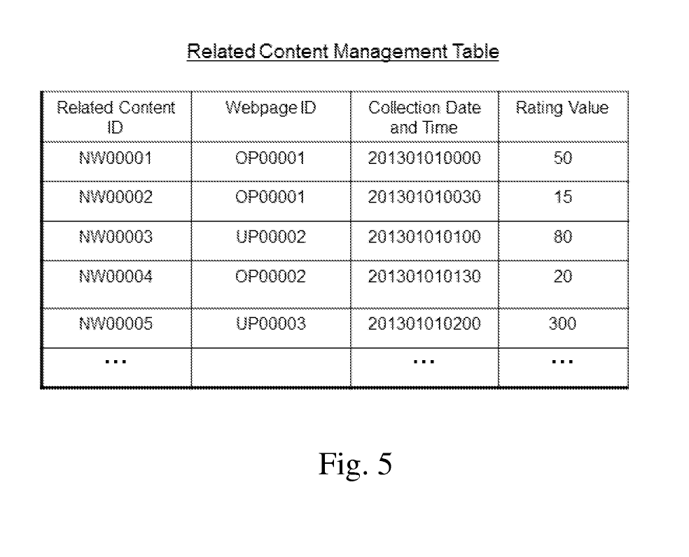

When the related content collecting module 44 has collected related contents for a particular webpage, the related content collecting module 44 may record information concerning the collected related contents in the related content DB 53. In one embodiment, the related content DB 53 may include a related content management table illustrated in FIG. 5. Specifically, when the related content collecting module 44 has collected a related content for a particular webpage, the related content collecting module 44 may issue a “related content ID” identifying the related content and may record various items of information concerning the related content in the related content management table in association with the related content ID. As illustrated in FIG. 5, a “subject page ID” identifying the particular webpage, a “collection date and time” at which the related content has been collected, and a “rating value” calculated on the basis of rating information for the related content may be recorded in the related content management table in association with a related content ID. The related content management table may be updated every time a new related content has been collected. The related content management table illustrated in FIG. 5 is an illustrative only; the related content management table does not need to include all of the items illustrated and may include an additional item.

The rating accepting module 45 may acquire rating information representing ratings for post contents and related contents that are included in user pages and operator pages from users. A user can access a user page or an operator page to rate a post content and a related content contained in the webpages. For example, a user page may be configured to display a rating button for inputting a rating in association with a post content to allow a user to operate the rating button to input a rating for the post content. The rating information thus input by the user may be sent to the server 10, where the rating accepting module 45 may accept the rating information. Since feed information including a post content and/or a related content may be provided to a user as will be described later, the user can input rating information for the post content and/or the related content included in the feed information as well.

The rating value calculating module 46 may determine a rating value for a post content or a related content accepted by the rating accepting module 45 on the basis of rating information for the post content or the related content on the basis of rating information concerning the post content or the related content. For example, every time rating information for a post content or a related content is acquired from a user, the rating calculating module 46 can add a predetermined value (for example “1”) to an existing rating value for the post content or the related content to obtain a new rating value. For example, rating information for the post content identified by the post content ID “CM00001” in FIG. 4 is acquired, the rating value calculating module 46 may add “1” to the rating value “35” associated with “CM00001” to obtain “36” as a new rating value and may update the post content DB 52 with the obtained new rating value “36”. Similarly, when the rating value calculating module 46 has obtained a new rating value of a related content, the rating value calculating module 46 may update the related content DB 53 with the obtained new rating value for the related content.

The rating accepting module 45 may acquire rating information representing a user's rating for a post content or a related content by using any of various methods apparent to those skilled in the art other than the method explicitly described herein. For example, a dialog box in which any of the integers ranging from “1” to “10” can be selected may be included in a webpage and feed information in association with a post content and a related content. Any integer selected using the dialog box may be sent to the server 10 as rating information.

The selecting module 47 may select, for each of the operator pages among the webpages provided by the webpage providing module 42, a particular post content included in feed information from among a plurality of post contents associated with each operator page in the post content DB 52. A content to be included in feed information among post contents is referred to as a “particular post content” herein. A particular post content may be selected on the basis of rating values recorded for post contents in the post content DB 52, for example. In a more specific example, the selecting module 47 may select a post content with a rating value higher than or equal to a predetermined threshold value (referred to as the “post content rating threshold value”), for example “30”, as the particular post content from among a plurality of post contents stored in the post content DB 52 in association with a given operator page. The threshold value may be a common value set for all users in common or different threshold values may be set by different users at the users' choice.

Referring to the post content management table in FIG. 4, a function of the selecting module 47 will be described in detail. As illustrated in FIG. 4, a record of a post content identified by the post content ID “CM00001” (hereinafter referred to as “post content 1”) and a record of a post content identified by the post content ID “CM00006” (hereinafter referred to as “post content 6”) are associated with a webpage identified by the webpage ID “OP00001” in the post content management table in the embodiment illustrated. Since the rating value for post content 1 is “35” and the rating value for post content 6 is “15”, the selecting module 47 selects post content 1 as a particular post content and does not select post content 6 as a particular post content when the post content rating threshold value is “30”.

In an alternative embodiment of the present invention, the selecting module 47 can select a particular post content on the basis of “date and time of posting” in addition to “rating values”. For example, the selecting module 47 may select a post content with a “rating value” greater than or equal to a predetermined threshold value and a “date and time of posting” that is within one hour of a predetermined reference time, for example the current time, as a particular post content. By selecting a particular post content on the basis of “date and time of posting” in addition to “rating values” in this way, a post content that has a high rating given by users and is relatively new can be selected as a particular post content and included in feed information. Accordingly, post contents that have high ratings but have older dates and times of posting can be filtered out so as not to be included in feed information.

The algorithm for selecting a particular post content used in the selecting module 47 is not limited to the one described above; any of various algorithms may be used to select a particular post content to feed from among post contents. For example, post contents generated by quoting from posts made by other users (for example contents equivalent to retweets in Twitter (trademark)) may be excluded This allows post contents created by users by themselves to be included in particular post contents.

The feed information generating module 48 may generate feed information for each of webpages provided by the webpage providing module 42. In embodiments of the present invention, the feed information on a user page may include post contents posted on the user page, related contents collected for the user page and, besides these contents, update information on the user page and activities performed on the webpage (such as downloading of an application and a setting of a new friendship). Instead of a post content or a related content included in feed information, a part of the content (for example the first two lines of a comment or the headline of a news article) or URL information indicating the location on the network where the content is stored may be included in the feed information in order to reduce the data amount of the feed information.

The feed information on an operator page may include particular post contents selected by the selecting module 47 from among post contents posted on the operator page, related contents collected for the operator page and, besides these contents, update information on the operator page, and activities performed on the webpage (such as downloading of an application).

The feed information delivery module 49 may deliver a feed generated by the feed information generating module 48 to a given user. For example, when feed information is generated for the user page of a given user, the feed information delivery module 49 may check the user information DB 51 to identify users in a friendship with the user and may deliver the generated feed information to terminal devices 30 of the users in the friendship. When feed information is generated for a given operator page, the feed information delivery module 49 may check the user information DB 51 to identify users who have “subscribed” to the webpage and may deliver the generated feed information to terminal devices 30 of the identified users. The users to whom feed information is delivered may also be determined using any of various other well-known methods.

Feed information delivered by the feed information delivery module 49 can be displayed on a terminal device 30 as a part of the user page of a user who has received the feed information. Details of the display of feed information on a terminal device 30 will be described later.

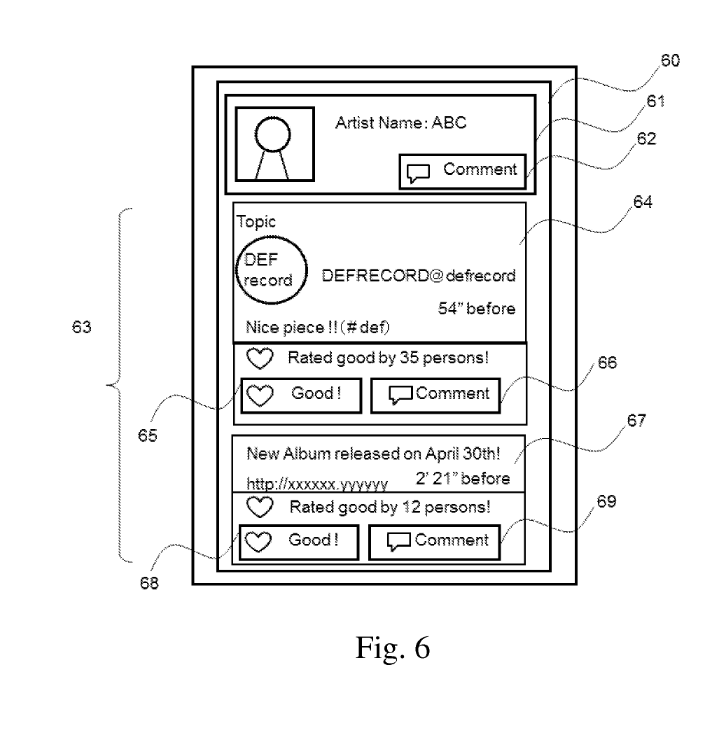

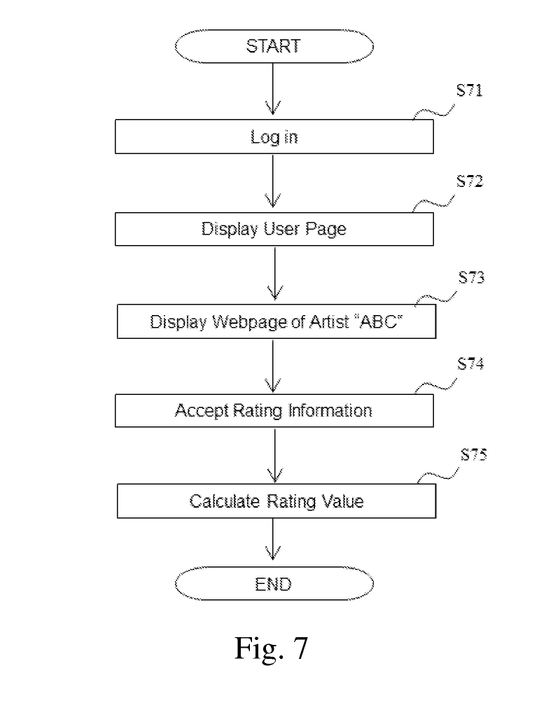

Referring to FIGS. 6 to 11, operations of the server 10 will now be described. FIG. 7 is a flowchart illustrating a process flow from an operation for logging in the SNS to calculation of a rating value for a content according to one embodiment of the present invention.

First, at step S71, a user may use the user's account and password to log into the SNS provided by the server 10. When authentication of the user is successful, the process may proceed to step S72, where a user page of the user may be displayed on a terminal device 30 of the user. In this way, user pages may be presented to the users of the SNS as the top page of SNS sites.

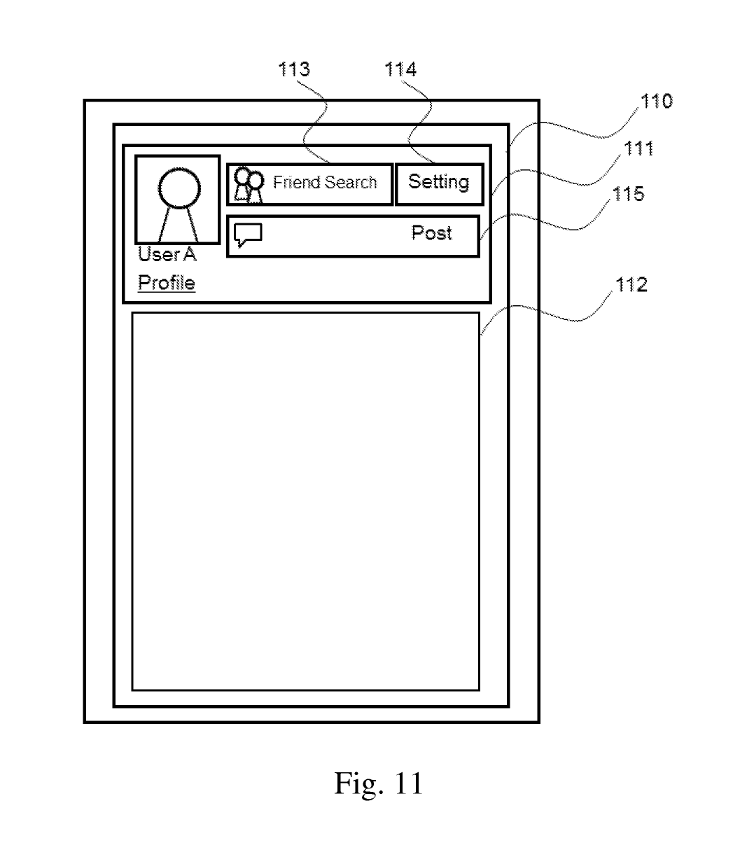

A user page may include various kinds of information relating to the user or the user page, such as the profile of the user to whom the user page is allocated, post contents posted by the user and other users. FIG. 11 illustrates an example of a user page displayed on a terminal device 30. As illustrated, the user page 110 may include a menu display region 111 including operation buttons as well as the user's name (a nickname on the SNS) and profile information and a feed display region 112 displaying feed information provided from the server 10. Post contents and related contents included in feed information delivered by the feed information delivery module 49 may be displayed in the feed display region 112. The menu display region 111 may include a search button 113 for searching for a friend, a setting change button 114 for changing various settings for using the SNS such as privacy settings for post contents and the frequency of updating the feed display region 112, and a post button 115 for posting a post content, in addition to the user's name and profile information.

Then, the process may proceed to step S73, where the user may access an operator page provided on the SNS. For example, the user may access a webpage of an artist “ABC” (hereinafter referred to the “artist page”), which is an operator page. When a request to access the artist page is issued by the user, the web providing module 42 may generate the requested artist page on the basis of posted contents, related contents and other information recorded in the storage 15 in association with the artist page (in association with the webpage ID of the artist page).

FIG. 6 is an example of display of an artist page (an operator page) on a terminal device 30. As depicted in FIG. 6, the artist page 60 may include a heading region 61 displaying the subject or name of the artist page 60, a post button 62 for posting a post content such as a comment on the artist page 60, and a content display region 63 displaying post contents posted in association with the artist page 60 and collected related contents in a predetermined order (for example in chronological order).

The post button 62 may be an operation button for accepting an input of a post content from the user. When the user selects the post button 62, a screen for accepting a comment from the user is displayed on the terminal device 30 and the user can input a comment using an input unit of the terminal device 30. In addition to an input of a comment, any of various kinds of contents such as a photograph, a video and a musical piece can be selected as a post content by operating the post button 62. After inputting a comment and/or selecting a content such as a photograph, a video or a musical piece, the user can send the post content including the input comment and/or the selected photograph, video or musical piece to the server 10.

A plurality of contents can be displayed in the content display region 63. In the example in FIG. 6, the content display region 63 includes a first display region 64 and a second display region 67. Comments from users, which are an example of post content, are displayed in the first display region 64. A news article concerning a release of a new album, which is an example of related comment, acquired from an external site is displayed in the second display region 67. The webpage providing module 42 may retrieve post contents and related contents stored in association with the webpage ID identifying the artist page from the content storage area 54 and may embed the retrieved contents in the content display region 63 to generate an artist page. The contents displayed in the content display region 63 may be updated whenever a new post content is acquired by the post content acquiring module 43 or a new related content is collected by the related content collecting module 44. For convenience of explanation, a post content displayed in the first display region 64 is hereinafter referred to as “post content 1”. It is assumed here that post content 1 is identified by the post content ID “CM00003”.

A rating button 65 for inputting a rating for the post content and a comment button 66 for posting a comment on the post content are displayed in association with content 1 displayed in the first display region 64. In the second display region, a rating button 68 for inputting a rating for a news article and a comment button 69 for posting a comment on the news article are displayed in association with the news article (a related content) concerning new album release information.

When the rating button 65 is selected by the user, the terminal device 30 may generate rating information representing a favorable rating for post content 1 associated with the rating button 65 and may send the generated rating information to the server 10. When the rating information sent from the terminal device 30 is received by the server 10, the process proceeds to step S74, where the received rating information is accepted by the rating accepting module 45.

Then the process proceeds to step S75, where the rating value calculating module 46 may determine a rating value for post content 1 on the basis of the rating information accepted by the rating accepting module 45. Specifically, the rating value calculating module 46 may refer to the post content management table in FIG. 4 and add “1” to the rating value associated with the post ID “CM00003” of post content 1 to determine a new rating value of content 1. In the example illustrated in FIG. 4, “1” is added to the rating value “75” associated with the post content ID “CM00003” to obtain a new rating value, “76”, for post content 1. The rating value for the post content ID “CM00003” in the post content management table is updated with the obtained new rating value.

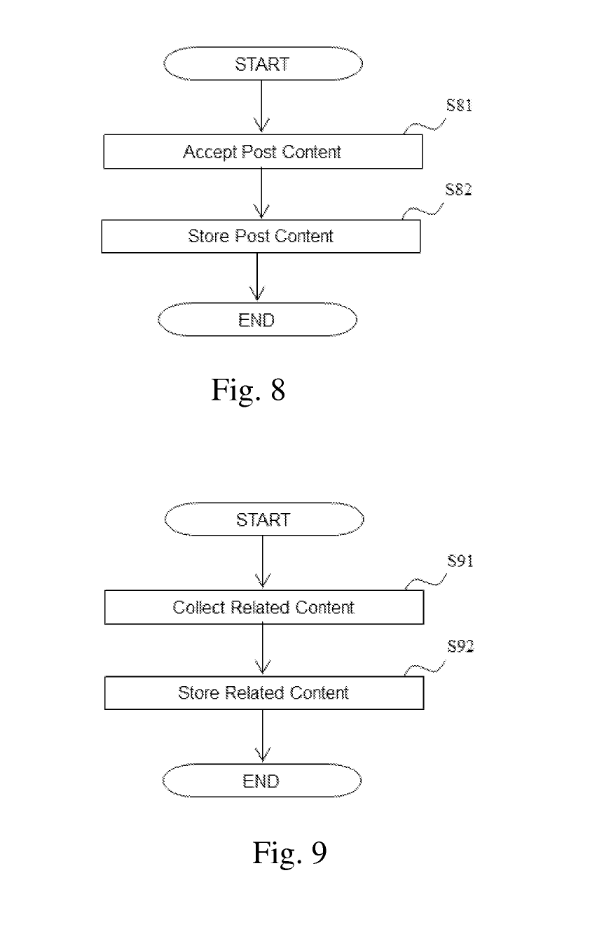

A process for accepting a post content performed at the server 10 will now be described with reference to FIG. 8. As illustrated, first a post content sent from a terminal device 30 may be accepted by the post content acquiring module 43 at step S81. Specifically, the post content acquiring module 43 may assign a “post content ID” to the accepted post content, may record the “user ID” of the user who has posted the post content in association with the post content ID and may record a “post destination ID” identifying a user page or an operator page to which the post content is to be posted in the post content management table. If the post content includes a given identifier such as a hashtag described previously, the post content acquiring module 43 may record the identifier as a “tag” in association with the post content ID. Further, the post content acquiring module 43 may refer to a date and time acquired from a clock (not depicted) and may record the “date and time of posting” that is the date and time at which the post content has been accepted. Since rating information has not been accepted at the time of creation of a record for the post content, “0” is input in the “rating value”.

Then, the post content acquiring module 43 may send and store the accepted content into the content storage area 54 at step S82. The post content accepting process described above may be executed every time a new post content is accepted. The post content accepting process can be executed at the server 10 in parallel with the operations illustrated in FIG. 7.

A process for collecting related contents performed at server 10 will now be described with reference to FIG. 9. When the related content collecting process is started, first the related content collecting module 44 may collect a content that meets a predetermined condition as a related content from an external site provided in a domain different from the domain of the website hosted by the server 10 at step S91. The related content collecting module 44 can cause a well-known crawler to visit various webpages one after another to collect contents relating to a given webpage as related contents for the webpage. The related content collecting module 44 can use a keyword predetermined for a given webpage, for example, to collect webpages that contain the keyword in their bodies or meta-tags.

The related content collecting module 44 then updates the related content management table according to the specifics of the collected related contents. Specifically, the related content collecting module 44 may assign a “related content ID” to a collected related content and may record the “user page ID” or “operator page ID” of the webpage to be associated with the related content in association with the “related content ID”. The related content collecting module 44 may also record a “date and time of collection” indicating the date and time at which the related content has been collected and a “rating value” for the related content in association with the “related content ID”. Since no “rating value” for the related content has been accepted at the time of collection of the related content, “0” is input in the “rating value”.

Then the related content collecting module 44 may send and store the collected related content into the content storage area 54 at step S92. The related content collecting process described above may be periodically executed at predetermined time intervals, for example. The related content collecting process can be executed at the server 10 in parallel with the operations illustrated in FIG. 7 and the post content accepting process illustrated in FIG. 8.

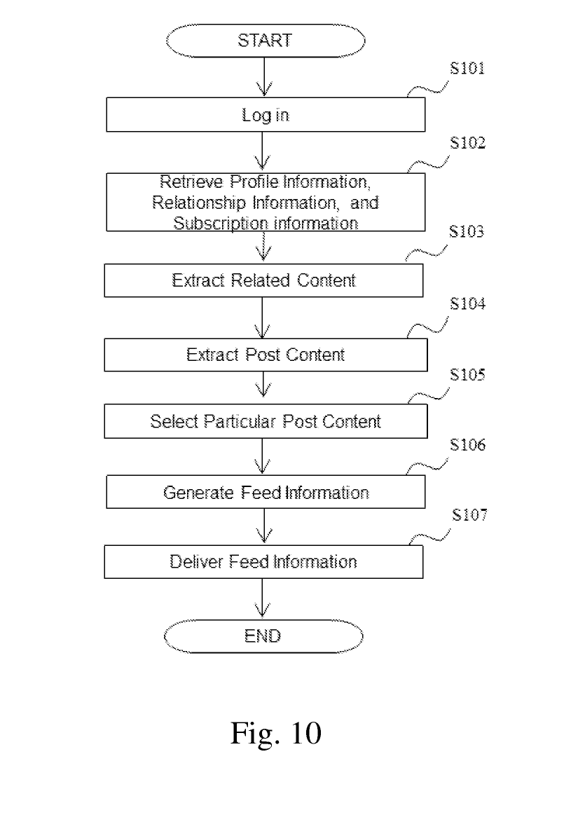

A process from logging in by user A to delivery of feed information to the user page of user A will be described with reference to FIG. 10. First, user A may use the user's account and password to log into the SNS provided by the server 10 at step S101. When authentication of the user is successful, the process may proceed to step S102, where profile information of user A, relationship information indicating a relationship such as a friendship between user A and other users, and subscription information indicating a webpage to which user A has subscribed are extracted from the user information DB 51.

The process then proceeds to step S103, where a related content to be fed to the user page of user A may be extracted. First, in the related content management table in FIG. 5, a related content ID associated with the user page of a user in a friendship with user A may be extracted at step S102. For example, if the user page ID of a user in a friendship with user A is “UP00002”, the related content ID “NW00003” associated with “UP00002” in the related content management table in FIG. 5 may be extracted. Then the related content stored in the content storage area 54 in association with the extracted related content ID “NW00003” may be retrieved from the content storage area 54.

Also at step S103, the related content ID stored in association with a webpage to which user A has subscribed may be extracted on the basis of the subscription information of user A. For example, if user A has subscribed to the operator page identified by the operator page ID “OP00001”, the related content IDs “NW00001” and “NW00002” recorded in the related content management table in FIG. 5 in association with the operator page ID “OP00001” are extracted. Then related contents stored in the content storage area 54 in association with the extracted related content IDs “NW00001” and “NW00002” may be retrieved from the content storage area 54.

When the related contents to be fed to the user page have been retrieved as described above, the process proceeds to step S104, where a post content to be fed to the user page of user A may be selected. First, in the post content management table in FIG. 4, the post content ID associated with the user page of a user in a friendship with user A that has been extracted at S102 may be extracted. For example, if the user page ID of the user in a friendship with user A is “UP00002”, the post content ID “CM00004” associated with “UP00002” in the post content management table in FIG. 4 may be extracted

At step S104, the post content ID stored in association with a webpage to which user A has subscribed may be extracted on the basis of the subscription information of user A. For example, if user A has subscribed to the operator page identified by the operator page ID “OP00001”, the post content IDs “CM00001” and “CM00006” recorded in association with the operator page ID “OP00001” in the post content management table in FIG. 4 may be extracted.

Then the process proceeds to step S105, where a particular post content to be included in feed information to be provided to user A may be selected from among the post contents extracted at step S104. Specifically, a particular post content may be selected from among the three post contents identified by the extracted post content IDs “CN00001”, “CM00004” and “CM00006” on the basis of the rating values recorded in the post content management table in FIG. 4. For example, a post content having a rating value greater than or equal to a predetermined threshold value, for example “30”, may be selected as a particular post content. In this embodiment, the three post contents with the post contents IDs “CM00001”, “CM00004” and “CM00006” have been retrieved at step S104 and their rating values are “35”, “15” and “15”, respectively. Accordingly, the post content with “CM00001” that has a rating value greater than the threshold value “30” is selected as a particular post content.

Then the process proceeds to step S106, where the feed information generating module 48 may generate feed information including the related content extracted at step S103 and the particular post content selected at step S105.

Then the process proceeds to step S107, where the feed information generated at step S106 may be delivered to the terminal device 30 of user A by the feed information delivery module 49. The feed information delivery module 49 may embed the feed information in a part of a user page and may send the user page with the embedded feed information to the terminal device 30 of user A to deliver the feed information to user A. In an alternative embodiment, the feed information delivery module 49 may send a user page that does not include the feed information to the terminal device 30, then send the feed information for the user page to the terminal device 30, where the feed information may be embedded in the user page.

The process from step S103 to step S107 may be repeated every time data concerning a post content or a related content in the post content management table or the related content management table is updated. Furthermore, the process from step S103 to step S107 may be periodically executed at predetermined time intervals. The processes illustrated in FIG. 10 can be performed at the server 10 in parallel with the processes illustrated in FIGS. 7 to 9.

As has been described above, according to embodiments of the present invention, only the contents that have attained ratings greater than or equal to a certain value among the post contents stored on a website for SNS are included in feed information. In this way, according to embodiments of the present invention, post contents posted by users can be appropriately filtered. Moreover, since only the post contents that have attained definite ratings are fed to other users, an incentive to post contents that can attain high ratings from other users is given to users of SNS. Consequently, posting of contents that attract the interest of other users is promoted, thereby stimulating communication among users on SNS.

Since the operator of an SNS creates operator pages concerning subjects that attract the interest of many users, it is conceivable that many users may subscribe to the operator pages. Consequently, far more post contents such as comments are likely to be posted on the operator pages than user pages. In one embodiment of the present invention, post contents posted on a user page are included in feed information regardless of the rating values for the post contents whereas only those post contents on an operator page that have attained high ratings can be included in feed information. Accordingly, the post contents posted on a user page are included in feed information fed to other users in a friendship with the user of the user page regardless of the ratings for the posted contents, therefore only post contents posted on an operator page on which a large number of post contents are posted and which greatly needs filtering can be filtered without hindering communications among users through user pages.

While processes and procedures recited herein may have been described as being performed by a single device, a single piece of software, a single component or a single module, such processes or procedures can be performed by a plurality of devices, a plurality of pieces of software, a plurality of components and/or a plurality of modules. Furthermore, data, tables or databases recited herein may have been described as being stored in a single memory, such data, tables, or databases can be stored in a distributed manner in a plurality of memories provided in a single device or in a plurality of memories distributed in a plurality of devices. Moreover, software elements and hardware elements described herein can also be implemented by integrating the elements into fewer components or separating the elements into a larger number of components.

Components of the invention recited herein as being one of singular and plural or described without qualifying as neither of singular and plural may be either singular or plural unless the context requires otherwise.

In any of the process procedures described herein, especially in any of the process procedures described with reference to flowcharts, some of the steps of the process procedure can be omitted, a step that has not explicitly been stated as a step of the process procedures can be added, and/or the sequence of the steps can be altered, and any process procedure to which such omission, addition or sequence alteration has been made is fall within the scope of the present invention without departing from the spirit of the present invention.

1. An information providing system comprising one or more processors capable of executing a given program, the information providing system providing information through a website,
the program comprising:
a webpage providing module configured to provide, to a plurality of users of the website, a particular webpage within the website and a user page assigned to each of the plurality of users, the particular webpage being managed by an administrator of the website;
a post content acquiring module configured to acquire a plurality of post contents posted by one or more users included in the plurality of users in association with the particular webpage and a user page post content posted by one or more users included in the plurality of users in association with the user page;
a rating accepting module configured to accept rating information representing a rating for at least one of the plurality of post contents from one or more users included in the plurality of users a selecting module configured to select one or more particular post contents from among the plurality of post contents on the basis of the rating information;
a feed information generating module configured to generate particular feed information including the one or more particular post contents and the user page post content not subjected to selection based on the rating information; and
a feed information delivery module configured to deliver the particular feed information.

2. The information providing system according to claim 1,
wherein the webpage providing module provides the particular feed information delivered by the feed information delivery module in association with a user page allocated to a user to whom the particular feed information has been delivered.

3. The information providing system according to claim 1, further comprising a user information managing module configured to manage one or more users included in the plurality of users in association with the particular webpage,
wherein the feed information delivery module delivers the particular feed information to one or more users associated with the particular webpage by the user information managing module.

4. The information providing system according to claim 1, further comprising a rating value calculating module configured to determine a rating value for each of the plurality of post contents on the basis of the rating information,
wherein the selecting module selects as the particular post content a post content having a rating value greater than or equal to a predetermined threshold value from among the plurality of post contents.

5. The information providing system according to claim 1,
wherein the post content acquiring module acquires as the post content a content posted from the particular webpage.

6. The information providing system according to claim 1,
wherein the post content acquiring module acquires a content posted in association with an identifier associated with the particular webpage as the post content.

7. The information providing system according to claim 1,
wherein the selecting module selects the one or more particular post contents from among the plurality of post contents on the basis of the rating information and the times at which the plurality of post contents have been posted.

8. A computer-readable storage medium storing an information providing program for providing information through a website, the information providing program causing a computer to:
provide, to a plurality of users of the website, a particular webpage within the website and a user page assigned to each of the plurality of users, the particular webpage being managed by an administrator of the website;
acquire a plurality of post contents posted by one or more users included in the plurality of users in association with the particular webpage and a user page post content posted by one or more users included in the plurality of users in association with the user page;
accept rating information representing a rating for at least one of the plurality of post contents from one or more users included in the plurality of users;
select one or more particular post contents from among the plurality of post contents on the basis of the rating information;
generate particular feed information including the one or more particular post contents and the user page post content not subjected to selection based on the rating information; and
deliver the particular feed information.

9. An information providing method executed by a computer providing information through a website, the information providing method comprising:
providing, to a plurality of users of the website, a particular webpage within the website and a user page assigned to each of the plurality of users, the particular webpage being managed by an administrator of the website;
acquiring a plurality of post contents posted by one or more users included in the plurality of users in association with the particular webpage and a user page post content posted by one or more users included in the plurality of users in association with the user page;
accepting rating information representing a rating for at least one of the plurality of post contents from one or more users included in the plurality of users;
selecting one or more particular post contents from among the plurality of post contents on the basis of the rating information;
generating particular feed information including the one or more particular post contents and the user page post content not subjected to selection based on the rating information; and
delivering the particular feed information.
